(19) United States
(12) Patent Application Publication
(10) Pub. No.: US 2006/0076097 A1
(43) Pub. Date: Apr. 13, 2006

(54) Wheel Structure

(76) Inventor: Sung-Wang Yang, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/959,151

(22) Filed: Oct. 7, 2004

(51) Int. Cl. B60C 15/02

(52) U.S. Cl. 152/379.5

(57) ABSTRACT

A wheel structure includes a tire, a hub, pads and fastening elements. The tire has a hollow body with a pair of hub holes to receive the hub therein. Each hub hole is provided with an engaging wall and a securing edge extending outwardly form the engaging wall. The hub has a pair of confining sections at respective ends. Each confining section has a confining groove with a plurality of holes thereon. Each pad is formed with a plurality of locating holes corresponding to the holes of each confining groove so as to secure the pads to the hub and to restrain the tire to the hub securely.

### BACKGROUND OF THE INVENTION

1. Field of the Invention

This invention relates to a wheel structure, and more particularly to a wheel that is easy to mount and to dismount with a hand tool.

2. Description of the Prior Art

An all-terrain vehicle requires a wide and soft tire for its stability and to grab the sand. However, the beach is always full of tree trunks, debris, or even some broken bottles. These objects may poke the tire and damage the tire.

It requires special tools to mount and to dismount the tire. That causes a user's inconvenience.

### SUMMARY OF THE INVENTION

It is the primary advantage of the present invention to provide a wheel structure, which is easy to mount and to dismount.

It is another advantage of the present invention to provide a wheel structure, which is easy to maintain.

It is a further advantage of the present invention to provide a wheel structure, which is safe to users.

### BRIEF DESCRIPTION OF THE DRAWINGS

FIG. 1 is an exploded view of the present invention;

FIG. 2 is a cross-sectional view of the present invention; and

FIG. 3 is a perspective view of another embodiment of the present invention.

### DETAILED DESCRIPTION OF THE PREFERRED EMBODIMENT

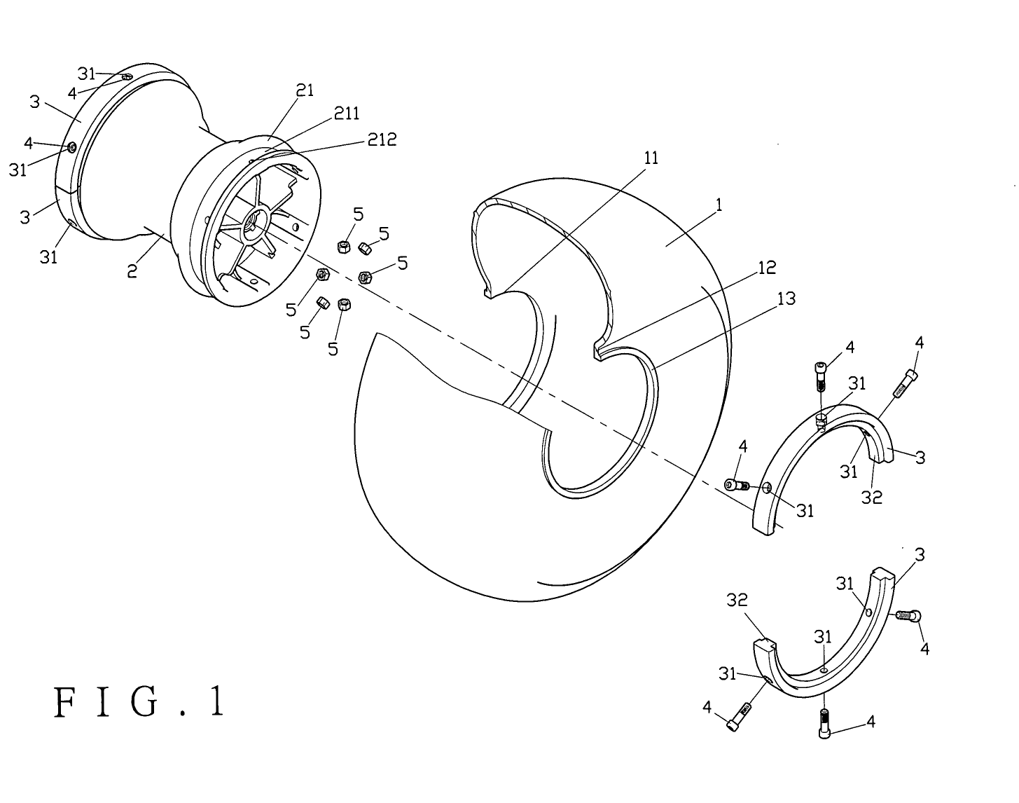

As shown in FIG. 1, the present invention comprises a tire 1, a hub 2, pads 3, and fastening elements. The fastening elements are consisted of bolt 4 and nuts 5.

The tire 1 has a hollow body with a pair of hub holes 11 adapted to receive the hub 2 therein. Each hub hole 11 is provided with an engaging wall 12 and a securing edge 13 extending outwardly from the engaging wall 12.

The hub 2 comprises a pair of confining sections 21 at respective ends. Each confining section 21 comprises a confining groove 211 having a plurality of holes 212 thereon.

Each pad 3 comprises a plurality of locating holes 31 corresponding to the holes 212 of the confining groove 211. A flange 32 is formed around the inner wall of the pad 3.

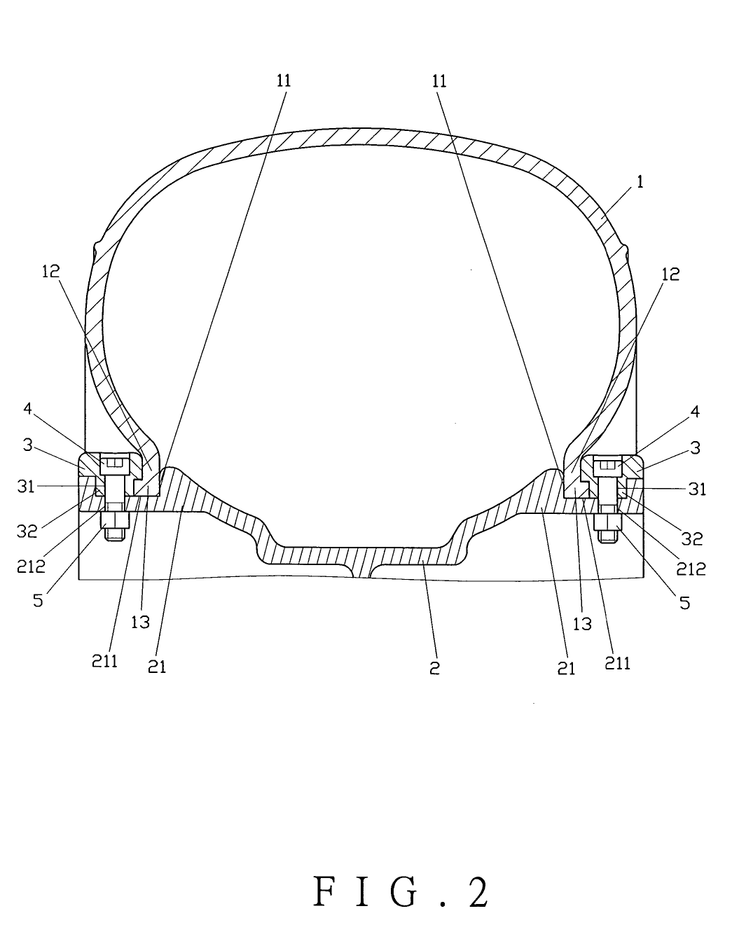

To assemble, as shown in FIG. 2, the hub 2 is inserted into the hub holes 11 of the tire 1. The engaging wall 12 and the securing edge 13 of each hub hole of the tire 1 are confined to locate in the confining groove 211 of each confining section 21 of the hub 2. Two pads 3 are placed on each side of the hub 2 with their flanges 32 seating in the confining groove 211 of each confining section 21 of the hub 2. The bolts 4 are inserted through the locating holes 31 of the pads 3 and the holes 212 of the confining grooves 211, and then fastened with the nuts 5. The pads 3 force the engaging wall 12 and the securing edge 13 of each hub hole 11 of the tire 1 to be confined in the confining groove 211. Thus the tire 1 is securely fastened to the hub 2. It is merely operated by a hand tool, such as a wrench to mount or dismount the tire 1 and hub 2.

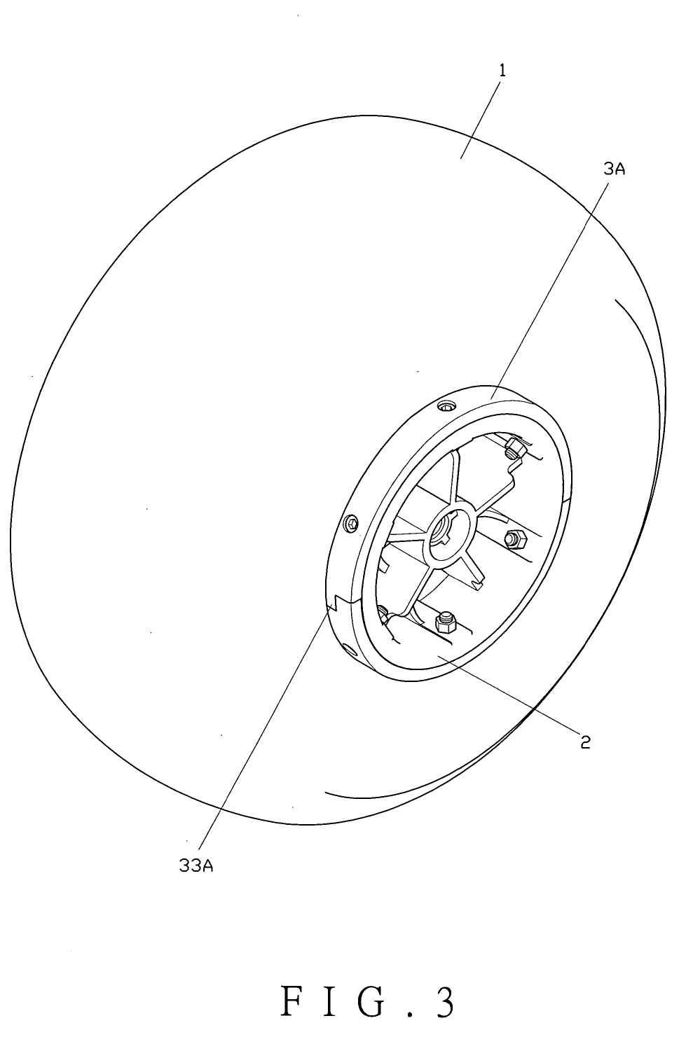

FIG. 3 shows a second embodiment of the present invention. Each pad 3A is provided with engaging ends 33A at respective ends to facilitate engagement of the pads 3A to be secured to the hub 2.

I claim:

1. A wheel structure comprising a tire, a hub, pads, and fastening elements, wherein:
said tire having a hollow body with a pair of hub holes to receive said hub therein, each hub hole being provided with an engaging wall and a securing edge extending outwardly from said engaging wall;
said hub comprising a pair of confining grooves at respective ends, each confining groove comprising a plurality of holes;
each pad comprising a plurality of locating holes corresponding to said holes of said confining groove;
said hub being inserted into said hub holes of said tire, said engaging wall and said securing edge of each hub hole of said tire being confined to locate in said confining groove of said hub and secured by fastening elements to secure thereat.

2. The wheel structure, as recited in claim 1, wherein said fastening elements are bolts and nuts, said bolts being inserted through said locating holes of each pad and said holes of each confining groove and secured by said nuts.

3. The wheel structure, as recited in claim 1, wherein each pad is provided with a flange inwardly.

4. The wheel structure, as recited in claim 1, wherein each pad is provided with engaging ends at respective ends to facilitate engagement
